(19) United States
(12) Patent Application Publication
(10) Pub. No.: US 2022/0182181 A1
(43) Pub. Date: Jun. 9, 2022

(54) OPERATING METHOD OF SELF-SERVICE TERMINAL AND SELF-SERVICE TERMINAL

(71) Applicant: ELO TOUCH SOLUTIONS, INC., MILPITAS, CA (US)

(72) Inventors: Yin SUN, SHANGHAI (CN); Hua SHAO, SHANGHAI (CN)

(73) Assignee: ELO TOUCH SOLUTIONS, INC., MILPITAS, CA (US)

(21) Appl. No.: 17/604,815

(22) PCT Filed: Apr. 22, 2020
(86) PCT No.: PCT/US2020/029208

§ 371 Date: Oct. 19, 2021

(30) Foreign Application Priority Data
Apr. 25, 2019 (CN) 201910336406.X

(51) Int. Cl. H04L 1/00; G06Q 20/20; H04L 1/16; G06Q 20/18

(52) U.S. Cl. CPC H04L 1/0083; G06Q 20/18; H04L 1/1628; G06Q 20/20

(57) ABSTRACT

An operating method of a self-service terminal. The method includes receiving a first frame from the application module; and determining whether the first frame is valid, processing the body portion of the first frame if valid, and not processing the body portion of the first frame if not. The body portion of the first frame includes a command field, and processing the body portion of the first frame includes parsing the command field to obtain an entity that the first frame is for, and performing operations according to the entity. If the entity is one or more devices in the device module, then a second frame is constructed for the one or more devices, and the second frame is transmitted to the one or more devices. If the entity is the control module, then an operation is performed based on the body portion of the first frame.

### TECHNICAL FIELD

The present disclosure relates to the field of self-service technology, and in particular to an operating method of a self-service terminal and a self-service terminal.

### BACKGROUND

Current self-service, such as self-purchase, self-order, self-checkout, self-service business handling, typically uses a self-service terminal.

Accordingly, there is a need for new technologies.

### SUMMARY

One of aims of the present disclosure is to provide an operating method of a self-service terminal and a self-service terminal.

One aspect of this disclosure is to provide an operating method of a self-service terminal. The self-service terminal comprises an application module configured to provide an application to a user, a device module comprising a plurality of devices, and a control module configured for a communication between the application module and the device module. The method comprises the following performed by the control module: receiving a first frame from the application module, wherein the first frame includes a body portion; and determining whether the first frame is valid, processing the body portion of the first frame if valid, and not processing the body portion of the first frame if not, wherein the body portion of the first frame includes a command field, and processing the body portion of the first frame comprises: parsing the command field to obtain an entity that the first frame is for, and performing first operations according to the entity, wherein the first operations comprises: if the entity is one or more devices in the device module, constructing a second frame for the one or more devices based on the body portion of the first frame and a predefined rule between the control module and the one or more devices, and transmitting the second frame to the one or more devices; and if the entity is the control module, performing an operation based on the body portion of the first frame.

Another aspect of this disclosure is to provide an operating method of a self-service terminal. The self-service terminal comprises an application module configured to provide an application to a user, a device module comprising a plurality of devices, and a control module configured for a communication between the application module and the device module. The method comprises the following performed by any first entity of the application module, the control module, and one or more devices of the device module: receiving a first frame, the first frame including a head portion, a body portion, and a tail portion; determining whether the head portion of the first frame is correct, performing a subsequent operation if correct, and not performing any subsequent operation on the first frame if not; and determining whether the entire first frame is valid, processing the body portion of the first frame if valid, and not processing the body portion of the first frame if invalid.

Another aspect of this disclosure is to provide a self-service terminal. The self-service terminal comprises an application module configured to provide an application to a user, a printer, and a control module for a communication between the application module and the printer, wherein the control module is configured to: receive a first frame from the application module; and determine whether the first frame is valid, processing the first frame if valid, and not processing the first frame if not, wherein the first frame includes a command field indicating one or more entities that the first frame is for and one or more operations associated with the one or more entities, and a data field associated with the one or more operations, and processing the first frame comprises: parsing the command field to obtain the one or more entities and the one or more operations, and performing the following operations according to the one or more entities: if the one or more entities include the printer, constructing a second frame for the printer based on the one or more operations, the data field, and a predefined rule between the control module and the printer, and transmitting the second frame to the printer; and if the one or more entities include the control module, performing an operation based on the one or more operations and the data field.

Further features of the present disclosure and advantages thereof will become apparent from the following detailed description of exemplary embodiments with reference to the attached drawings.

### BRIEF DESCRIPTION OF THE DRAWINGS

The accompanying drawings, which constitute a part of the specification, illustrate embodiments of the present disclosure and, together with the description, serve to explain the principles of the present disclosure.

The present disclosure will be better understood according the following detailed description with reference of the accompanying drawings.

FIG. 1 is a diagram schematically showing at least a part of a self-service terminal according to some embodiments of the present disclosure.

FIG. 2 is a diagram schematically showing a frame configuration applicable to an operating method of a self-service terminal according to some embodiments of the present disclosure.

FIG. 3 is a diagram schematically showing an operating method of a self-service terminal according to some embodiments of the present disclosure.

FIG. 4 is a diagram schematically showing an operating method of a self-service terminal according to some embodiments of the present disclosure.

FIG. 5 is a diagram schematically showing at least a part of a self-service terminal according to some embodiments of the present disclosure connecting with servers.

FIG. 6 is a diagram schematically showing an operating method of a self-service terminal according to some embodiments of the present disclosure.

FIG. 7 is a diagram schematically showing at least a part of a self-service terminal according to some embodiments of the present disclosure.

Note that, in the embodiments described below, in some cases the same portions or portions having similar functions are denoted by the same reference numerals in different drawings, and description of such portions is not repeated. In some cases, similar reference numerals and letters are used to refer to similar items, and thus once an item is defined in one figure, it need not be further discussed for following figures.

### DETAILED DESCRIPTION

Various exemplary embodiments of the present disclosure will be described in details with reference to the accompanying drawings in the following. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit this disclosure, its application, or uses. It should be understood by those skilled in the art that, these examples, while indicating the implementations of the present disclosure, are given by way of illustration only, but not in an exhaustive way.

The term “A or B” used through the specification refers to “A and B” and “A or B” rather than meaning that A and B are exclusive, unless otherwise specified.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the preceding technical field, background, summary or detailed description.

In addition, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, integers, steps, operations, elements, and/or components, but do not preclude the presence or addition of one or more other features, integers, steps, operations, elements, components, and/or groups thereof.

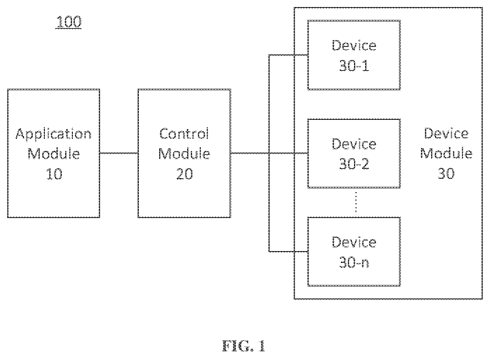

FIG. 1 is a diagram schematically showing at least a part of a self-service terminal 100 according to one or more embodiments of the present disclosure. The self-service terminal 100 may be, for example, a self-service vending machine, a self-service ticket-vending machine, a self-service ordering machine, a self-checkout machine, a self-service check-in machine, a self-service registering machine, a self-service paying machine, a kiosk, and the like. The self-service terminal 100 includes an application module 10, a control module 20, and a device module 30.

The application module 10 is configured to provide an application to a user. For example, the user may be a consumer, and the application module 10 may provide the user an application or a man-machine interface for self-purchase, self-order, self-checkout, self-service business handling, or the like. The application module 10 may only provide the user an interface for such an application or a man-machine interface rather than providing an application or a man-machine interface directly. For example, the application module 10 may provide a data interface to an application installed on another device (e.g., a smartphone) so that the user may perform self-service or operate the self-service terminal 100 via the application installed on the another device. For another example, the user may be a supervisor, and the application module 10 may provide the user an application or a man-machine interface for management or maintenance, or a data interface for such an application or a man-machine interface.

The device module 30 may include a plurality of devices 30-1, 30-2, , 30-n. One or more of the plurality of devices may be input/output devices for the self-service terminal 100. For example, a device in the device module 30 may be a printer, a scanner, a graphic code reader, a camera, a point of selling (POS) machine, a credit card reader, an electrical/magnetic tag detector, an ID card reader, a fingerprint reader, a multimedia player, an indicator light, a power controller, a fan, a keyboard, a touch button, a touch panel, a display, a thermometer, a hygrometer, a GPS positioning device or the like. When referring to the device module 30 herein, in accordance with the context, it may refer to all of the devices 30-1, 30-2, , 30-n, or may also refer to one or more of the devices 30-1, 30-2, , 30-n.

The control module 20 is configured for a communication between the application module 10 and the device module 30, such that the application module 10 may not directly communicate with the device module 30. A communication connection may be established between the control module 20 and the application module 10, and between the control module 20 and the device module 30 through various wired or wireless communication interfaces, including but not limited to, a USB interface, a COM interface, a UART interface, a GPIO interface, an SPI interface, an I2C interface, a Bluetooth interface and so on. In addition to the communication between the application module 10 and the device module 30, the control module 20 may also be configured to supply power to the application module 10 and/or the device module 30, and initiate a communication to the application module 10 or the device module 30 by itself.

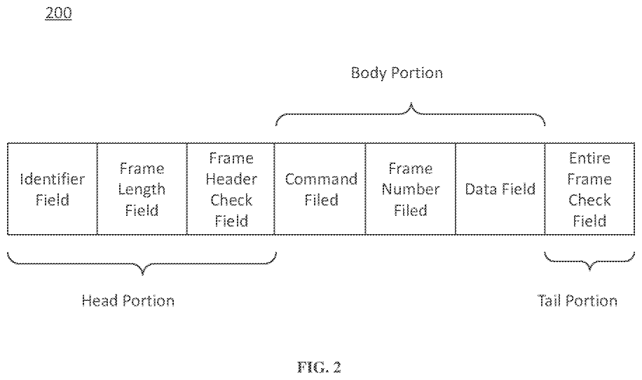

FIG. 2 is a diagram schematically showing a frame configuration 200 applicable to an operating method of a self-service terminal according to some embodiments of the present disclosure. A frame configuration is a predefined format for transceiving between two communicating entities. The frame configuration 200 may be used in communications between entities in a self-service terminal. For example, the frame configuration 200 may be applied in communications between the control module 20 and the application module 10, and/or between the control module 20 and the device module 30 according to a predefined rule.

The frame configuration 200 may comprise a head portion, a body portion and a tail portion. The head portion may include an identifier field, a frame length field, and a frame header check field. The identifier field may be a predefined value for the communication between two entities. The frame length field indicates the length (e.g., maybe in bytes) of the entire frame (from the identifier field of the frame configuration 200 to the entire frame check field described below). The frame header check field may be used to check the head portion. In a specific example, the length of the identifier field may be 1 byte, the predefined value of the identifier field between the control module 20 and application module 10, and between the control module 20 and the device module 30, may both be 0x7E; the length of the frame length field may be 2 bytes; and the length of the frame header check field may be 1 byte. In some embodiments, the frame header check field may be a sum of a byte-by-byte modulo-2 addition of content included in the head portion other than the frame header check field, that is, a sum of a byte-by-byte modulo-2 addition of the identifier field and the frame length field. Thus, the algorithms both for generating the frame header check field by the sender and for checking the head portion based on the frame header check field by the receiver are simple, which helps to improve the processing speed.

The body portion may include a command field, a frame number field, and a data field. The command field may be used to indicate one or more of the following: one or more entities that the frame is for, one or more operations associated with the one or more entities, the attributes of the one or more entities (e.g., one or more of identity information for identifying the entity, port information indicating a port to which the entity is connected, and address information indicating an address of the entity in the self-service terminal), whether the frame is a frame for a segment transmission, the reception result of a frame transmitted before the frame, and the like. The length of the command field may be defined in advance between two entities communicating with each other in accordance with the amount of information to be carried in the frame. In some embodiments, the command field of the body portion may indicate an address pointing to a piece of memory on which information for indicating the entity that the frame is for, the operation associated with the entity, the attribute of the entity, whether the frame is for a segment transmission, reception result of a frame transmitted before the frame or the like may all be stored. The sender of the frame may write such information on the piece of memory, and the receiver may read the information from the piece of memory according to the address indicated by the command field.

The frame number field indicating the sequence number of the frame may be used to identify a frame that is transmitted and received repeatedly, and may also be used to sort a plurality of associated frames received under a segment transmission. In a specific example, the length of the frame number field is 2 bytes and the frame number field ranges from 0x0000 to 0xFFFF cyclically.

The data field may include data related to the operation of the entity that the frame is for, and the length of the data field may be variable and may be calculated based on the length of the entire frame indicated by the frame length field. In some embodiments, the data field of the body portion may be an address pointing to a piece of memory on which data associated with the operation of the entity are stored, such that the sender of the frame may write the data on the piece of memory, and the receiver may read the data from the piece of memory according to the address indicated by the data field.

The tail portion may include an entire frame check field, which may be used to check the entire frame. The length of the entire frame check field may be 1 byte. In some embodiments, the entire frame check field may be a sum of a byte-by-byte modulo-2 addition of content included in the entire frame other than the entire frame check field, that is, a sum of a byte-by-byte modulo-2 addition of the identifier field, the frame length field, the frame header check field, the command field, the frame number field, and the data field. Thus, the algorithms both for generating the entire frame check field by the sender and for checking the entire frame based on the entire frame check field by the receiver are simple, which helps to improve the processing speed.

An operating method of a self-service terminal according to one or more exemplary embodiments of the present disclosure is described below in accordance with specific examples.

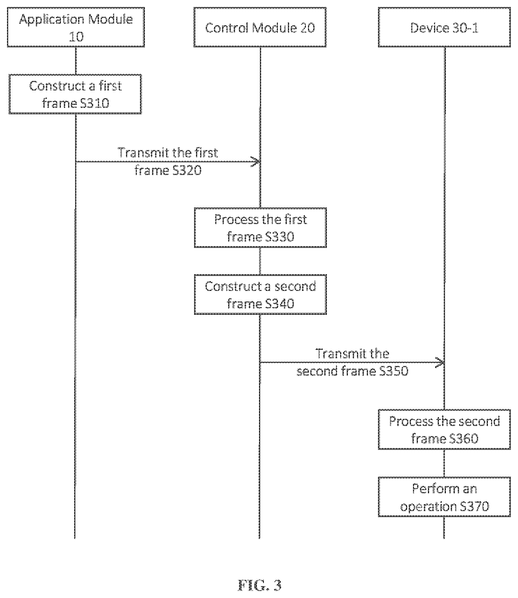

Example 1: The application module 10 instructs one or more devices in the device module 30 to perform a specific operation (as shown in FIG. 3). Some exemplary scenarios may be, the application module 10 instructs the printer in the device module 30 to print a shopping list, the application module 10 instructs the indicator light in the device module 30 to emit light in a specific color and a specific pattern and instructs the multimedia player to play a specific audio file, and the application module 10 instructs the fan in the device module 30 to rev up and the like. Those skilled in the art should understand that these scenarios are only exemplary and not exhaustive or limiting, and the technical solutions of the present disclosure can also be applied to other scenarios. An operating method of a self-service terminal in these scenarios is described below in accordance with a specific example and FIG. 3.

As shown in FIG. 3, the application module 10 may construct (S310) one or more first frames for instructing the device 30-1 in the device module 30 to perform operations, and transmit (S320) the one or more first frames to the control module 20. The first frame may have a configuration similar to the frame configuration 200 as shown in FIG. 2. The command field of the body portion of the first frame may indicate an entity (i.e., the device 30-1 in the example shown in FIG. 3) that the first frame is for, and one or more operations related to the entity. The data field of the body portion may include data related to the operation to be performed by the entity. In a specific example, the first frame may be a frame constructed by the application module 10 to instruct the printer to print a shopping list, wherein the command field of the body portion indicates the entity that the first frame is for is the printer, the operation related to the printer is printing, and the data related to the printing operation is carried in the data field of the body portion. A frame number field of the body portion is used to indicate the sequence number of the first frame communicating between the application module 10 and the control module 20. In a specific example, the application module 10 is a master unit and the control module 20 is a slave unit in the communication between the application module 10 and the control module 20, and the frame number of the communication between the two units is maintained by the master unit, i.e., the application module 10. Further, the first frame may include a head portion and a tail portion of the frame configuration 200.

When the amount of data related to the operation to be performed by the entity is too large to be carried in a single first frame, the data may be transmitted using a plurality of first frames. For example, a plurality of first frames will be used for a “segment transmission” which will be described below. In this case, the application module 10 may add information to indicate the first frame is a frame for a segment transmission during constructing the first frame, and may even add information to indicate how many first frames are used for this segment transmission. These information may be presented in the command field of the body portion. In addition, in the case of a segment transmission, the frame number field of the body portion may also be used to indicate the order of sorting the associated plurality of first frames, for example, sorting based on the frame number field in ascending or descending order consecutively, such that the control module 20 may, after receiving these associated plurality of first frames, sort these first frames based on the frame number field, and may also determine if there is a first frame for this segment transmission is missing according to whether the frame numbers of these first frames are consecutive.

Since the first frame constructed and transmitted by the application module 10 to instruct the device 30-1 to perform operations is not sent directly to the device 30-1 but sent to the control module 20, the meaning of each of the fields in the first frame needs only to comply with a predefined rule between the application module 10 and the control module 20, rather than complying with a desired format of the device 30-1. For example, for the application module 10 and the control module 20, it may be defined in advance that some bytes in the command field are used to indicate the entity that the first frame is for, some bytes are used to indicate the operations related to the entity, and the relationship between the values of the bytes and the meanings thereof. These predefined rules may be different from those rules defined between the control module 20 and the device module 30, for example, may not comply with the rules described in the product manual of the device 30-1 in the device module 30.

The control module 20 may receive and process (S330) the first frame, construct (S340) a second frame according to the content of the first frame, and transmit (S350) the second frame to the entity that the first frame is for, e.g., the device 30-1 in the device module 30. After receiving the first frame, the control module 20 may check the first frame to determine whether the first frame is valid based on the head portion and the tail portion of the first frame (the approach to determine whether the first frame is valid will be described in detail below). If the first frame is valid, the control module 20 may process the body portion of the first frame, and otherwise, the control module 20 may discard the first frame without processing the first frame anymore or constructing the second frame. The frame configuration of the second frame transmitted by the control module 20 to the device 30-1 needs to comply with the rules predefined between the control module 20 and the device 30-1. For example, such rules may be rules described in the product manual of the device 30-1, or the frame configuration 200 shown in FIG. 2.

Processing the body portion of the first frame by the control module 20 may include parsing the command field to obtain an entity, e.g., the device 30-1, that the first frame is for. The device module 30 typically comprises a plurality of devices 30-1, 30-2, . . . , 30-n, the plurality of devices 30-1, 30-2, . . . , 30-n being connected to corresponding ports of the control module 20 via respective interfaces. After determining the device 30-1 that the first frame is for by parsing the command field, the control module 20 may transmit the second frame to the device 30-1 via the port that the device 30-1 is connected to.

In addition, the control module 20 may further obtain operations associated with the device 30-1 indicated in the first frame by parsing the command field of the body portion. The control module 20 may construct the command field of the body portion of the second frame based at least on the predefined rule with the device 30-1 and the operations associated with the device 30-1, so that the command field of the body portion of the second frame may instruct the device 30-1 to perform specific operations in the form of being complying with the rule that can be parsed by the device 30-1. Since being transmitted directionally from the control module 20 to the device 30-1, the second frame does not need to indicate in the command field the entity that the second frame is for, but only needs to indicate the operations to be performed by device 30-1.

In a specific example, the command field in the body portion of the first frame indicates the device 30-1 that the first frame is for is a printer, and the control module 20 determines that the first frame is for the printer by parsing the command field of the first frame. Since the printer is connected to one of COM ports of the control module 20, and the control module 20 control the second frame constructed to be sent to the one of COM ports to transmit the second frame to the printer. The control module 20 also determines the operation indicated in the first frame to the printer by parsing the command field of the first frame. For example, the operation may be printing in a default format, printing in a specific format, printing in a specific language, printing with a specific page width, or the like. The control module 20 instructs, in the second frame, the printer to perform the operation indicated in the first frame.

The content to be printed by the printer is embodied in the data field of the body portion of the first frame. Constructing the second frame by the control module 20 further comprises constructing the data field of the body portion of the second frame based on the predefined rule between the control module 20 and the printer (i.e., device 30-1), and the content of the data field in the body portion of the first frame. In the case that the rule of the data field defined between the control module 20 and the application module 10 is the same as the rule of the data field defined between the control module 20 and the device 30-1, the control module 20 may not process the data field of the first frame, but packing the data field in the body portion of the first frame to the data field in the body portion of the second frame. In the case of the predefined rule between the control module 20 and the device 30-1 being that the data field in the body portion is an address pointing to a piece of memory, constructing the second frame by the control module 20 further comprises storing the data related to the operation of the device 30-1 into an address that the device 30-1 is able to access, and carrying the address in the data field of the body portion of the second frame.

Since the transmission rate between the control module 20 and the application module 10 does not generally match that between the control module 20 and the device module 30, in the case where a first frame is for segment transmission, the control module 20 may not transmit a corresponding second frame after receiving a first frame. For example, the control module 20 may buffer a plurality of associated first frames received by a receiving process on one hand in spite of the progress of constructing/transmitting the corresponding second frames. And on the other hand, the control module 20 may construct second frames respectively based on the buffered first frames and transmit the second frames one by one by a transmitting process to the device 30-1 in a predefined order (e.g., ascending or descending) according to the frame number indicated by the frame number field in spite of the progress of receiving the corresponding first frames.. The control module 20 may determine which frame is the associated frame for the same segment transmission based on the information that whether the frame is for a segment transmission and how many frames are used for this segment transmission indicated in the command field.

In the case of the second frame having the frame configuration 200 shown in FIG. 2, the control module 20 may also arrange the frame number field in the body portion of the second frame. In some embodiments, in the communication between the devices 30-1, 30-2, . . . , 30-n in the device module 30 and the control module 20, one of the devices 30-1, 30-2, . . . , 30-n is a master unit, and the control module 20 is a slave unit. The frame number for the communication between the two units is maintained by the master unit, i.e., one of the devices 30-1, 30-2, . . . , 30-n. When constructing the second frame for the device 30-1, the control module 20 may obtain the frame number of the second frame by adding 1 to the frame number indicated in the frame that is the last communication frame between the control module 20 and the device 30-1. If it is sent to the device 30-1 for the first time, the frame number field of the second frame is set to a predefined initial frame number (for example, 0x0000, 0x0001, or oxFFFF, etc.).

The device 30-1 receives and processes (S360) the second frame, and performs (S370) an operation indicated by the second frame based on the data related to the operation. In the case of the second frame having the frame configuration 200 shown in FIG. 2, after receiving the second frame, the device 30-1 may determine whether the second frame is valid based on the head portion and the tail portion of the second frame, process the body portion of the second frame if valid to obtain an operation that is instructed to be performed and data related to the operation, and perform the instructed operation according to the obtained information. In the case where a plurality of associated second frames are used for a same segment transmission, the device 30-1 may perform a related operation every time a second frame is received (for example, the printer may print a part of the data after receiving the data part carried in a second frame), and may also perform the related operation when the plurality of associated second frames are received completely (for example, the printer may buffer the plurality of associated second frames, and then print all of the data in an order according to the frame number field of these second frames after all of them are received). Thus, a procedure that the application module 10 instructs a device 30-1 to perform a specific operation may be implemented.

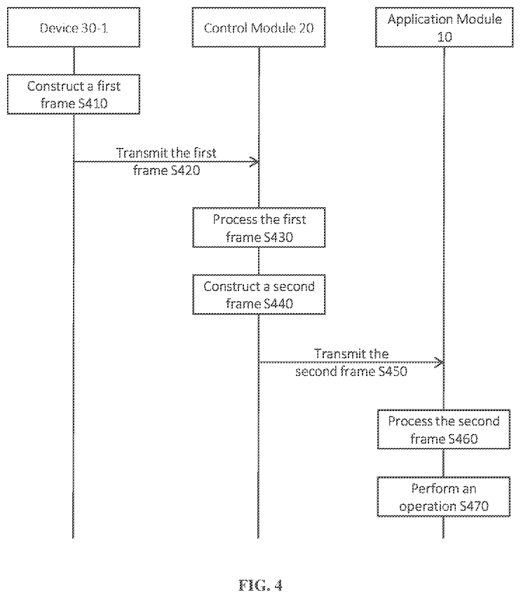

Example 2: The device module 30 reports its information including states, operations attributes, etc. to the application module 10 (as shown in FIG. 4). Some exemplary scenarios may be that a thermometer/hygrometer in the device module 30 may report measured temperature/humidity to the application module 10, a product detector in the device module 30 may report an ID code of a product to the application module 10, a printer in the device module 30 may report a warning of low ink to the application module 10. Those skilled in the art should understand that these scenarios are only exemplary and not exhaustive or limiting, and the technical solutions of the present disclosure can also be applied to other scenarios. An operating method of a self-service terminal in these scenarios is described below in accordance with a specific example and FIG. 4.

As shown in FIG. 4, the device 30-1 may construct (S410) one or more first frames for reporting its state, operation, attribute, or the like to the application module 10, and transmit (S420) the first frame to the control module 20. The frame configuration of the first frame needs to follow the predefined rules between the control module 20 and the device 30-1. For example, such rules may be the rules described in the product manual of the device 30-1, or the frame configuration 200 shown in FIG. 2. In the case where the first frame having the frame configuration 200 shown in FIG. 2, the command field in the body portion of the first frame may indicate a state change (e.g. temperature change, malfunction, etc.) of the device 30-1, an operation (e.g., being triggered by a user, for example, a button is pressed, a touch panel is touched, a product detector detects a product, etc.), or the like. The data field of the body portion may include data related to the state change or the operation of the device 30-1, such as data of payment code read by a code reader, a password entered by a user via a POS machine, data measured by the thermometer/hygrometer, and a code of a malfunction occurred in the device 30-1, and so on. The frame number field in the body portion may be used to indicate a sequence number of the first frame of the communication between the control module 20 and the device 30-1. In some embodiments, in the communication between the device 30-1 and the control module 20, the device 30-1 may be a master unit, the control module 20 may be a slave unit, and the frame number of the communication between the two units is maintained by the master unit, i.e., the device 30-1. Further, the first frame may include a head portion and a tail portion of the frame configuration 200.

When the amount of data to be transmitted is too large to be carried in a first frame, the data may be transmitted using a plurality of first frames. In this case, the device 30-1 may add information for indicating the first frame is a frame for a segment transmission during constructing the first frame, and may even add information for indicating how many first frames are used for this segment transmission. These information may be presented in the command field of the body portion. In addition, in the case of a segment transmission, the frame number field of the body portion may also be used to indicate the order of sorting the associated plurality of first frames.

The control module 20 may receive and process (S430) the first frame, construct (S440) a second frame according to the content of the first frame, and transmit (S450) the second frame to the application module 10. After receiving the first frame, the control module 20 may check the first frame to determine whether the first frame is valid based on the head portion and the tail portion of the first frame (the approach to determine whether the first frame is valid will be described in detail below). If the first frame is valid, the control module 20 may process the body portion of the first frame, and otherwise, the control module 20 may discard the first frame without processing the first frame anymore or constructing the second frame.

Processing the body portion of the first frame by the control module 20 may include parsing the command field in the body portion to obtain the information (such as a state, an operation, an attribute, etc.) reported by the device 30-1 via the first frame. The control module 20 may then construct the second frame for the application module 10 based on the information reported by the device 30-1 and the predefined rules between the control module 20 and the application module 10. The control module 20 may further indicate the entity, i.e., the device 30-1, related to the information in the command field of the second frame based on the predefined rules between the control module 20 and the application module 10. In addition, the control module 20 may further arrange a frame number field in the body portion of the second frame. Since the frame number is maintained by the master unit, i.e., the application module 10, the control module 20 may obtain the frame number of the second frame by adding 1 to the frame number indicated in the frame that is the last communication frame between the control module 20 and the application module 10. If it is sent to the application module 10 for the first time, the frame number field of the second frame is set to a predefined initial frame number (for example, 0x0000, 0x0001 or 0xFFFF, etc.).

In the case where a plurality of associated first frames are used for the same segment transmission, the control module 20 may construct and transmit a second frame every time a first frame is received, or may construct and transmit second frames respectively after all the plurality of associated first frames are received.

The application module 10 receives and processes (S460) the second frame, and performs (S470) corresponding operation based on the device 30-1 and the information of the device 30-1. After receiving the second frame, the application module 10 may determine whether the second frame is valid based on the head portion and the tail portion of the second frame, process the body portion of the second frame if valid to obtain the information of the device 30-1. For example, the application module 10 may thereby know an ID code of a product that is detected by a product detector so as to perform a related operation such as acquiring the price of the product or the like, may know the temperature in the self-service terminal measured by the thermometer so as to control the rotation speed of the fan in the self-service terminal accordingly, or may know that the printer has an low ink malfunction so as to control an alarm device to issue an alarm or notify a manager/supervisor via an application installed on a user device. Thus, a procedure that a device 30-1 reports its information to the application module 10 may be implemented.

Example 3: The application module 10 instructs the control module 20 to perform a specific operation, the control module 20 instructs the device module 30 to perform a specific operation, the control module 20 reports information to the application module 10, or the device module 30 reports information to the control module 20. In Example 3, the control module 20 communicates with the application module 10 or the device module 30 as an independent entity in the self-service terminal, instead of being used for the communication between the application module 10 and the device module 30. Some exemplary scenarios may be, for example, the application module 10 instructs the control module 20 to update a software version or update a firmware code version; the control module 20 reports its states, operations and/or attributes (e.g., a software or firmware code version, a malfunction state) to the application module 10; a thermometer reports a measured temperature inside the self-service terminal to the control module 20, and then the control module 20 controls directly the rotation speed of a fan so as to adjust the temperature inside the terminal instead of reporting the temperature to the application module 10.

In Example 3, the procedure that the application module 10 instructs the control module 20 to perform a specific operation may comprise, the application module 10 constructing one or more first frames for instructing the control module 20 to perform a specific operation, and transmitting the one or more first frames to the control module 20; the control module 20 receiving and processing the first frame to obtain, by parsing the command field, the entity that the one or more first frames are for is the control module 20; and then the control module 20 performing the corresponding operation based on the content of the one or more first frames, instead of constructing and transmitting a second frame.

The procedure that the control module 20 instructs the device module 30 to perform a specific operation may comprise, the control module 20 constructing one or more first frames for instructing the device 30-1 in the device module 30 to perform a specific operation, and transmitting the one or more first frames to the device 30-1; and the device 30-1 receiving and processing the first frame, and performing the corresponding operation based on the content of the one or more first frames.

The procedure that the control module 20 reports information to the application module 10 may comprise, the control module 20 constructing one or more first frames for reporting information to the application module 10, and transmitting the one or more first frames to the application module 10; and the application module 10 receiving and processing the first frame, and performing the corresponding operation based on the content of the one or more first frames.

The procedure that the device module 30 reports information to the control module 20 may comprise, the device 30-1 constructing one or more first frames for reporting information to the control module 20, and transmitting the one or more first frames to the control module 20; and the control module 20 receiving and processing the first frame, and performing the corresponding operation based on the content of the one or more first frames.

Example 4: Handshaking procedures between the devices 30-1, 30-2, , 30-n in the device module 30 and the control module 20 may be performed. After the devices 30-1, 30-2, . . . , 30-n are powered on, each of them may perform a handshaking procedure with the control module 20. All communications between entities during the handshaking procedure may use the frame configuration 200 shown in FIG. 2. For example, the device 30-1 may transmit a first frame to the control module 20 so as to notify the control module 20 of identity information of the device 30-1 by the way of predefined rules between the control module 20 and the device 30-1. For example, the device 30-1 may notify the control module 20 of the identity information (e.g., the device 30-1 is a printer) of the device 30-1 using the command field (or another field) in the body portion of the first frame. The control module 20 may receive the first frame from a specific port (e.g., a USB port) of all its ports, and obtain that the specific port is connected to a printer by parsing the first frame. Thus, after the handshaking procedure, when the application module 10 instructs the printer to perform an operation via the control module 20, the control module 20 knows how to forward the instruction to the printer, that is, through the specific USB port.

In some embodiments, the control module 20 may also notify the device 30-1 of the port information that indicates to which port the device 30-1 is connected using a second frame having the frame configuration 200 shown in FIG. 2. Thus, after the handshaking procedure, the control module 20 may know a message is from which device as long as the message indicates the control module 20 of at least one of port information and identity information. In some embodiments, the device 30-1 does not need to know which port of the control module 20 that it is connected to, i.e., the device 30-1 does not need to know its port information, since the control module 20 knows which port corresponding to which device after the handshaking procedure between the control module 20 and the device 30-1.

In some embodiments, each of entities in the self-service terminal may be connected with each other via a local area network LAN. For example, the devices 30-1, 30-2, . . . , 30-n in the device module 30 are connected to the control module 20 via a LAN. In this case, during the handshaking procedure between the control module 20 and the device 30-1, 30-2, . . . , 30-n, address information (e.g., an IP address in the LAN) indicating addresses of the device 30-1, 30-2, . . . , 30-n in the self-service terminal may be notified to the control module 20 using the command field (or another field). During the communication with the control module 20 after the handshaking procedure, the device 30-1, 30-2, . . . , 30-n may notify the control module 20 of its address information using the command field (or another field) of a frame. Thus, the control module 20 may determine which device is the sender of the frame according to the address information in the command field of the frame.

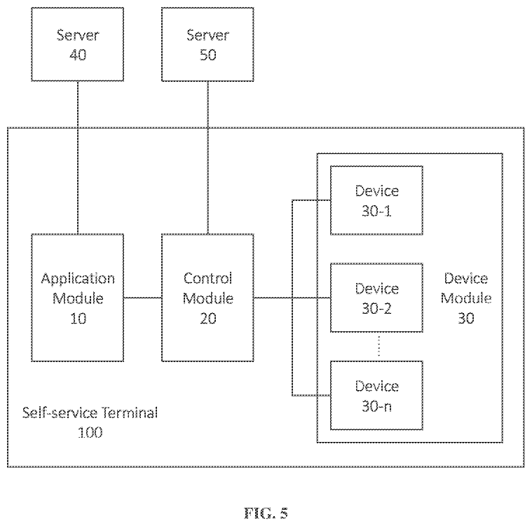

Example 5: The control module 20 uploads its stored data to the server. The server may be a local server or a cloud server. As shown in FIG. 5, the application module 10 in the self-service terminal 100 may be connected to a server 40, and the control module 20 may be connected to another server 50, wherein the server 40 and the server 50 may be the same or different servers. If the server 50 is a local server, the control module 20 may be connected to the server 50 through a UART port or a USB port or the like; if the server 50 is a cloud server, the control module 20 may be connected to the Internet through various wired or wireless network technologies to be connected to the server 50. Since the communication data (which includes data and instructions) related to the user operation always passes through the control module 20, the control module 20 will facilitate the server 50 to perform big data analysis if the communication data therethrough is stored and uploaded to the server 50, for example, analyzing which products are preferable to consumers or the like.

The control module 20 may transmit the stored data to the server 50 by transmitting one or more first frames to the server 50. The frame configuration of the first frame needs to follow a predefined rule between the control module 20 and the server 50, and may be, for example, the frame configuration 200 as shown in FIG. 2, or a frame configuration in the TCP/IP protocol or the like.

In the case where the first frame transmitted by the control module 20 to the server 50 has the frame configuration 200 as shown in FIG. 2, the control module 20 may transmit the data to be uploaded using the data field of the body portion of the first frame. In some embodiments, the control module 20 may also construct information indicating the address of the self-service terminal in a command field (or another field) of the body portion of the first frame, such that the address information of the self-service terminal corresponding to the data included in the data field may be known by the server 50 from the content of the first frame. In some embodiments, such address information may be an IP address of the self-service terminal accessing the Internet or a physical address at which the self-service terminal is placed. The physical address information may be obtained by the control module 20 through a positioning device (for example, a GPS positioning device) connected thereto, or may be configured to the control module 20 by a server, a host computer, or another device. The accuracy level of the physical address at which the self-service terminal is placed may be the store information in which the self-service terminal is placed, or may be a specific location where the self-service terminal is placed in a certain store (e.g., the north gate, the fresh zone, the middle region, or the like). The address information is uploaded to the server 50 along with the data stored by the control module 20, which will facilitate the server 50 to analyze information about different geographical locations, for example, which location has a larger traffic volume and thus need to install more self-service terminals in the location.

Example 6: Frame checking is performed when communicating between entities in the self-service terminal. Such frame checking is based on the frame configuration 200 shown in FIG. 2, and each entity of the application module 10, the control module 20, the device module 30, and the server 40, 50 may perform such frame checking on the received frames. In the following description of Example 6, the application module 10 constructing and transmitting the first frame to the control module 20, and the control module 20 checking the first frame is taken as an example. The procedure of communication between other entities is similar, the description of which is omitted.

Constructing the first frame by the application module 10 may comprise, arranging, in the head portion of the first frame, a predefined frame identifier as an identifier field, a frame length field indicating the length of the first frame, and a first check field for checking the head portion; arranging, in the tail portion of the first frame, a second check field for checking the entire first frame; and arranging, in the body portion of the first frame, a command field, a frame number field and a data field. Thus, the first frame is configured to have a frame configuration 200 as shown in FIG. 2. The algorithm for generating the first check field or the second check field may be any check value generation algorithm, which only needs to be determined in advance by the sender (i.e., the application module 10) and the receiver (i.e., the control module 20). For example, the algorithm for generating the first check field or the second check field may be a CRC check algorithm, an MD5 check algorithm, a SHA1 check algorithm, or the like. In some cases, the communication between the entities within the self-service terminal are close-range wired communication. Considering that such a communication environment is relatively reliable, a simple check value generation algorithm may be used, for example, a byte-by-byte modulo 2 addition. In this way, during constructing the first frame, the application module 10 perform a byte-by-byte modulo-2 addition to the content included in the head portion other than the first check field, and the accumulated sum (e.g., the length of the sum is 1 byte) is used as the first check field for checking the head portion. Similarly, the application module 10 perform a byte-by-byte modulo-2 addition to the content included in the first frame other than the second check field, and the accumulated sum (e.g., the length of the sum is 1 byte) is used as the second check field for checking the first frame.

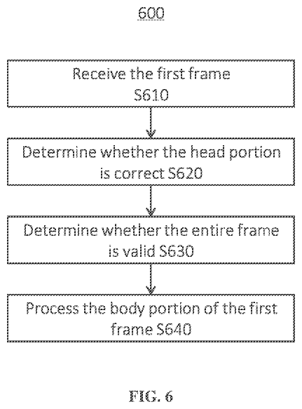

As shown in FIG. 6, the control module 20 receives (S610) the first frame, and then determines (S620) whether the head portion of the first frame is correct. If not correct, the control module 20 does not perform any subsequent operation on the first frame. If correct, the control module 20 determines (S630) whether the entire first frame is valid. If valid, the control module 20 processes (S640) the body portion of the first frame, and if not, the control module 20 does not process the body portion of the first frame.

In some embodiments, determining (S620) whether the head portion of the first frame is correct may include the following operations performed in sequence:

1) determining whether the identifier field belongs to one or more predefined frame identifier values, if so, performing a subsequent operation, and determining that the head portion is incorrect and not performing any subsequent operation on the first frame if not;

2) determining whether the frame length field belongs to one or more predefined frame length values, if so, performing a subsequent operation, and determining that the head portion is incorrect and not performing any subsequent operation on the first frame if not; and

3) determining whether the head portion is correct based on the first check field, for example, determining whether the first check field is a sum of a byte-by-byte modulo-2 addition of content included in the head portion other than the first check field, and if so, determining that the head portion is correct, and determining that the head portion is incorrect if not.

Those skilled in the art will appreciate that the above operations performed in sequence are only solutions in some embodiments of the present disclosure. In other embodiments, determining (S620) whether the head portion of the first frame is correct may include one or more of the above operations, for example, may include only operation 3), operations 1) and 3), operations 1) and 2), operations 2) and 3), or the like.

The “subsequent operation” referred to in the above description may include operations (for example, subsequent operations of operation 1) are operations 2) and 3)) in determining (S620) whether the head portion of the first frame is correct or not, and may also include one or more operations (for example, the operation of determining (S630) whether the entire first frame is valid, the operation of processing (S640) the body portion of the first frame, or the like) after determining (S620) whether the head portion of the first frame is correct or not.

In some embodiments, determining (S630) whether the entire first frame is valid may include: determining whether the second check field is a sum of a byte-by-byte modulo-2 addition of content included in the first frame other than the second check field, and if so, determining that the first frame is valid, and determining that the first frame is invalid if not.

Further, some checking operations on the first frame may also be performed during processing (S640) the body portion of the first frame. In some embodiments, checking operations on the first frame during processing (S640) the body portion of the first frame may include:

1) determining whether the value of the command field is within a predefined value range (e.g., the control module 20 determines whether the command field is in accordance with a predefined rule between the control module 20 and the application module 10), and if so, performing subsequent operations, otherwise not performing any subsequent operation on the first frame; and

2) parsing the command field to obtain an entity that the first frame is for, and determining whether the entity belongs to one or more predefined entities (e.g., the control module 20 determines whether the entity that the first frame is for is in accordance with a predefined rule between the control module 20 and the application module 10), and if so, performing subsequent operations, otherwise not performing any subsequent operation on the first frame.

Those skilled in the art will appreciate that checking operations during processing (S640) the body portion of the first frame may include fewer operations than operations 1) and 2) listed above, for example, may include only operation 1) or 2); and the checking operations may also include more operations than operations 1) and 2) listed above, for example, determining whether a state, an operation, identity information, port information, and address information or the like indicated by the command field is in accordance with a predefined rule between the control module 20 and the application module 10, and if so, performing subsequent operations, otherwise not performing any subsequent operation on the first frame.

The “subsequent operation” referred to in the above description may include an operation (for example, a subsequent operation of operation 1) is operation 2)) in checking operations on the first frame during processing (S640) the body portion of the first frame, an operation (for example, an operation of parsing the body portion of the first frame, etc.) after checking operations on the first frame during processing (S640) the body portion of the first frame, and an operation (for example, performing the operation indicated by the first frame or constructing a second frame, etc.) after processing (S640) the body portion of the first frame.

Example 7: Transmission quality control during communicating between entities in the self-service terminal may be performed. The transmission quality control may include: the receiver of a frame transmits a reception result to the sender after checking the frame according to Example 6; if the reception result received by the sender indicates a reception error, the sender transmits (or retransmits maybe) the frame; and if the receiver finds the frame number of the frame is not consecutive with the last received frame, the receiver may request the sender to transmit (or retransmit maybe) a frame corresponding to the missing frame number. Each of the application module 10, the control module 20, the device module 30, and the servers 40, 50 may perform such transmission quality control. In the following description of Example 7, the communication between the application module 10 and the control module 20 is taken as an example. The procedure of communication between other entities is similar, the description of which is omitted.

The application module 10 constructs and transmits a first frame to the control module 20, and the control module 20 can determine whether the head portion of the first frame is correct according to the method described in Example 6. If correct, the control module 20 performs subsequent operations. If not, the first frame will be discarded. In some embodiments, after the head portion of the first frame is determined to be incorrect, the control module 20 may send a second frame to the application module 10 to indicate a reception error. In other embodiments, after the head portion of the first frame is determined to be incorrect, the control module 20 may only discard the first frame (i.e., not perform any subsequent operation on the first frame) without sending a second frame to the application module 10 to indicate a reception error.

If it is determined that the head portion of the first frame is correct, the control module 20 may determine whether the entire first frame is valid according to the method described in Example 6. If it is valid, the control module 20 may perform subsequent operations. If not, the control module 20 may discard the first frame so that no further process on the first frame will be performed, and send a second frame to the application module 10 to indicate a reception error. If the control module 20 finds an error when checking the first frame in the procedure of processing the body portion of the first frame, the control module 20 may discard the first frame so that no further process on the first frame will be performed, and send a second frame to the application module 10 to indicate a reception error. If no error is found after all processes on the first frame are completed, the control module 20 may send a second frame to the application module 10 to indicate a reception success.

Such a second frame for indicating that the reception result is an error or a success may also have a frame configuration 200 as shown in FIG. 2, and the reception result may be embodied in the way of a predefined rule between the communicating entities. For example, a specified byte in the command field may be used to indicate the reception result with 0x00 representing a reception success and 0xff representing a reception error.

After transmitting the first frame to the control module 20, the application module 10 may receive a second frame transmitted by the control module 20 indicating the reception result. the application module 10 may parse the indication of the reception result in the second frame according to a predefined rule between the application module 10 and the control module 20. If the indication is a reception success, the application module 10 does not retransmit the first frame; and if the indication is a reception error, the application module 10 retransmit the first frame. A maximum number of transmissions (or a maximum number of retransmissions) may be predefined between the two communicating entities. If the number of transmissions of the first frame from the application module 10 to the control module 20 reaches the predefined maximum number of transmissions (or the number of retransmissions of the first frame reaches the predefined maximum number of retransmissions), the application module 10 does not retransmit the first frame even if the second frame transmitted by the control module 20 indicating a reception error.

The correspondence between the second frame and the first frame may be represented by a frame number field, and the correspondence may be predefined between the communication entities. For example, it may be predefined that the frame number of the second frame is the same as that of the corresponding first frame, or the frame number of the second frame is that of the corresponding first frame plus one. For example, if the frame number field of the first frame received by the control module 20 from the application module 10 is 0x1234, the frame number field of the second frame for indicating the reception result of the first frame may also be 0x1234. After receiving the second frame, the application module 10 may know the reception result of which frame is indicated in the second frame according to the frame number field in the second frame.

The control module 20 may further determine, according to the frame number field of the first frame, whether there is a missing frame from the application module 10, or whether the received frames from the application module 10 are duplicated.

Regarding the missing frame from the application module 10, in some embodiments, a predefined rule between the control module 20 and the application module 10 is that the frame numbers of the frames transmitted between the two should be consecutive. If the frame number of the last frame received from the application module 10 is n, and the frame number of the current frame received from the application module 10 is n+2, the control module 20 may request the application module 10 to transmit (or retransmit maybe) the missing frame whose frame number is n+1. In other embodiments, it is also feasible to predefine a rule between the control module 20 and the application module 10 that the frame numbers of the frames transmitted between the two may be not consecutive, then if the frame number of the last frame received from the application module 10 is not consecutive with that of the current frame, the control module 20 may not request the application module 10 to transmit any frame.

Regarding receiving duplicated frames from the application module 10, the control module 20 determines whether the frame number field of the first frame received from the application module 10 is identical with the frame number field of a frame received from the application module 10 before the first frame within a predefined time or within a predefined number of frames. If yes, it is determined that the first frame is a duplicated frame, and no subsequent operation will be performed on the first frame. It should be noted that since the length of the frame number field is limited, the value of the frame number field may be repeated. For example, if the frame number field has a length of 2 bytes, the predefined initial frame number between the two communicating entities is 0x0000, and the frame number maintenance rule is incremented by one each time. If the frame number field of the current frame is 0xFFFF, the frame number field of the next frame will be 0x0000, which is the same as the initial frame number. Therefore, when determining whether receiving duplicated frames or not, it is necessary to define that the two frames having the same frame number are within a predefined time or within a predefined number of frames. In the case of normal transmission and reception, the frame number within the predefined time or the predefined number of frames will not be repeated.

In some cases, when the amount of data that the application module 10 needs to be send to the control module 20 is too large to be carried in a single first frame, the data may be transmitted using multiple first frames (e.g., a segment transmission). In these cases, if the control module 20 determines that the first frame is a frame for segment transmission, after receiving the first frame and one or more frames for a segment transmission associated with the first frame, the control module 20 may: determine whether frame numbers indicated by frame number fields in the first frame and the one or more frames are consecutive, if consecutive, perform operations on the first frame and the one or more frames in a predefined order based on the frame number field; and if not, determine a missing frame number, construct a third frame based on the missing frame number, and transmit the third frame (in which a missing frame number is carried) to the application module 10 to indicate the application module 10 to transmit (or retransmit maybe) a frame corresponding to the missing frame number. After receiving the third frame indicating the missing frame number, according to the predefined rule between the control module 20 and the application module 10, the application module 10 may choose to transmit (or retransmit maybe) only the missing frame, or to transmit (or retransmit maybe) all the frames for the same segment transmission.

Although described in Example 7 is a communication mode with acknowledgment (i.e., transmitting a second frame indicating the reception result of the first frame), those skilled in the art will appreciate that a communication mode without acknowledgment can also be used between two communicating entities in the self-service terminal. For example, the communication mode with acknowledgment may be used for a frame whose command field value meets a first condition, and the communication mode without acknowledgment for a frame whose command field value meets a second condition.

Those skilled in the art will appreciate that the same or similar description is omitted in the above detailed description of the various examples for the sake of brevity.

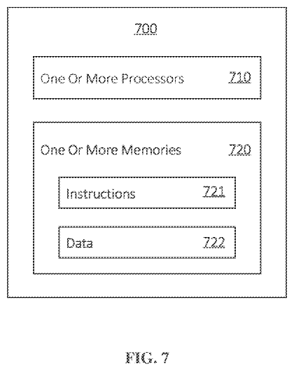

FIG. 7 is a diagram schematically showing at least a part of a self-service terminal 700 according to some embodiments of the present disclosure. The at least a part of a self-service terminal 700 can be, for example, one or more of the following: the application module 10, the control module 20, the device module 30, the devices 30-1, 30-2, . . . , 30-n, and the server 40, 50. The various functions described above, including the methods, operations, processes, steps, applications, procedures, etc. mentioned above, can be implemented in hardware, software, firmware, or any combination thereof. If implemented in software, the various functions may be implemented by one or more instructions 721 stored on a memory 720, such as a computer readable medium. If implemented in firmware, the various functions may be implemented by the processor 710 executing instructions 721, such as firmware code, stored on the memory 720. If implemented in hardware, various functions can be implemented by processing circuitry.

The at least a part of a self-service terminal 700, the control module 20 for example, includes one or more processors 710 and one or more memories 720, wherein one or more processors 710 are communicably coupled to one or more memories 720. One or more of the one or more memories 720 can be coupled to one or more processors 710 via a bus, port, or network, and/or can be directly coupled or incorporated in any one of the one or more processors 710. Each of the one or more memories 720 can store content that is accessible by one or more processors 710, including instructions 721 that can be executed by one or more processors 710, and data 722 that can be retrieved, manipulated, or stored by one or more processors 710.

The instructions 721 may be any set of instructions to be executed directly, such as machine code, or indirectly, such as scripts, by the one or more processors 710. The instructions 721 may be stored in object code format for direct processing by the one or more processors 710, or in any other computing device language including scripts or collections of independent source code modules that are interpreted on demand or compiled in advance. Functions, methods and routines of the instructions 721 are explained in more detail above.

The one or more memories 720 may be any transitory or non-transitory computer readable storage medium capable of storing contents accessible by the one or more processors 710, such as a hard drive, a memory card, an ROM, an RAM, a DVD, a CD, a USB memory, a write-enabled memory, a read-only memory or the like. The one or more memories 720 may include a distributed storage system where the instructions 721 and/or the data 722 are stored on a plurality of different storage devices which may be physically located at the same or different geographic locations.

The one or more processors 710 may retrieve, store or modify the data 722 in accordance with the instructions 721. The data 722 stored in the one or more memories 720 may include received multiple frames mentioned above including various fields in the frames, received multiple frames for a segment transmission, frames to be transmitted, data (for example, a payment code read from the user) related to one or more operations of one or more devices, and the like. Those skilled in the art will appreciate that other data may also be stored in one or more memories 720. For example, although the subject matter described herein is not limited by any particular data structure, the data 722 may also be stored in computer registers (not shown) as a table or XML document having many different fields and records stored in a relationship database. The data 722 may also be formatted in any computing device-readable format such as, but not limited to, binary values, ASCII or Unicode. In addition, the data 722 may include any information sufficient to identify relevant information, such as a serial number, descriptive text, a dedicated code, a pointer, references to data stored in other memories such as at other network locations, or information used by a function for computing related data.

The one or more processors 710 may be any conventional processors, such as a commercially available central processing unit (CPU), graphics processing unit (GPU), microprogrammed control unit (MCU), and the like. Alternatively, one or more of the processors 710 may also be dedicated components such as an application specific integrated circuit (ASIC) or other hardware based processor. Although not required, one or more processors 710 may include specialized hardware components to perform particular computing processes, such as checking the frames, etc., faster or more efficiently.

Although one or more processors 710 and one or more memories 720 are shown schematically in the same block in FIG. 7, one or more processors 710 or one or more memories 720 may actually include processors or memories that may exist in the same physical housing or in different physical housings. For example, one of the one or more memories 720 can be a hard drive or other storage medium located in a different housing than the housing of each of the one or more processors 710. Accordingly, references to processor or memory should be understood to include a collection of processors or memories that refer to possible parallel operations or possibly non-parallel operations. Although some of the functions described above are indicated to occur on a single computing device having a single processor, various aspects of the subject matter described herein can be implemented by multiple processors 710, for example, in communication with one another via network.

Moreover, although one or more processors 710 and one or more memories 720 are schematically illustrated in different blocks in FIG. 7, the at least a part of a self-service terminal 700 can be formed as a component, such as the processors 710, the memories 720, and various peripheral interfaces (such as a USB interface, an A/D conversion interface, and a UART interface, etc.) are integrated into a single chip to form a single chip microcomputer.

Although some specific embodiments of the present disclosure have been described in detail with examples, it should be understood by a person skilled in the art that the above examples are only intended to be illustrative but not to limit the scope of the present disclosure. The embodiments disclosed herein can be combined arbitrarily with each other, without departing from the scope and spirit of the present disclosure. It should be understood by a person skilled in the art that the above embodiments can be modified without departing from the scope and spirit of the present disclosure. The scope of the present disclosure is defined by the attached claims.

1. An operating method of a self-service terminal, the self-service terminal comprising an application module configured to provide an application to a user, a device module comprising a plurality of devices, and a control module configured for a communication between the application module and the device module, the method comprising the following performed by the control module:
receiving a first frame from the application module, wherein the first frame includes a body portion; and
determining whether the first frame is valid, processing the body portion of the first frame if valid, and not processing the body portion of the first frame if not,
wherein the body portion of the first frame includes a command field, and processing the body portion of the first frame comprises:
parsing the command field to obtain an entity that the first frame is for, and performing first operations according to the entity, wherein the first operations comprises:
if the entity is one or more devices in the device module, constructing a second frame for the one or more devices based on the body portion of the first frame and a predefined rule between the control module and the one or more devices, and transmitting the second frame to the one or more devices; and
if the entity is the control module, performing an operation based on the body portion of the first frame.

2. The method according to claim 1, wherein the first operations further comprise:
if the entity is one or more devices in the device module, parsing the command field to obtain one or more operations associated with the one or more devices indicated in the first frame, and constructing the second frame based on the one or more operations and the predefined rule between the control module and the one or more devices.

3. The method according to claim 1, wherein the method further comprises the following performed by the control module:
receiving a third frame from a first device in the device module, wherein the third frame includes a body portion; and
determining whether the third frame is valid, processing the body portion of the third frame if valid, and not processing the body portion of the third frame if not,
wherein the body portion of the third frame includes a command field, and the processing the body portion of the third frame comprises:
parsing the command field to obtain an entity that the third frame is for, and performing second operations according to the entity, wherein the second operations comprise:
if the entity is the application module, constructing a fourth frame for the application module based on the body portion of the third frame and a predefined rule between the control module and the application module, and transmitting the fourth frame to the application module; and
if the entity is the control module, performing an operation based on the body portion of the third frame.

4. The method according to claim 3, wherein the second operations further comprise:
if the entity is the application module, parsing the command field to obtain information associated with the first device indicated in the third frame, and constructing the fourth frame based on the information and the predefined rule between the control module and the application module.

5. The method according to claim 4, wherein the information comprises one or more of:
a state, an operation, a version, identity information for identifying the first device, port information indicating a port of the control module to which the first device is connected, and address information indicating an address of the first device inside the self-service terminal.

6. The method according to claim 1, wherein constructing the second frame comprises:
arranging, in the second frame, a check field for checking the second frame; and
arranging, in a body portion of the second frame, a command field indicating one or more operations associated with one or more devices that the second frame is for.

7. The method according to claim 3, wherein constructing the fourth frame comprises:
arranging, in the fourth frame, a check field for checking the fourth frame; and
arranging, in a body portion of the fourth frame, a command field indicating information associated with the control module to the application module.

8. The method according to claim 7, wherein the information comprises one or more of a state, an operation, a version, and an address inside the self-service terminal.

9. The method according to claim 1, wherein the control module is further configured to communicate with a server outside the self-service terminal, and the method further comprises the following performed by the control module:
constructing a fifth frame, comprising:
arranging, in the fifth frame, a check field for checking the fifth frame; and
arranging, in a body portion of the fifth frame, a command field indicating a physical address of the self-service terminal to the server; and
transmitting the fifth frame to the server.

10. The method according to claim 9, wherein constructing the fifth frame further comprises:
arranging, in a body portion of the fifth frame, a data field including data transmitted to the server.

11. An operating method of a self-service terminal, the self-service terminal comprising an application module configured to provide an application to a user, a device module comprising a plurality of devices, and a control module configured for a communication between the application module and the device module, the method comprising the following performed by any first entity of the application module, the control module, and one or more devices of the device module:
receiving a first frame, the first frame including a head portion, a body portion, and a tail portion;
determining whether the head portion of the first frame is correct, performing a subsequent operation if correct, and not performing any subsequent operation on the first frame if not; and
determining whether the entire first frame is valid, processing the body portion of the first frame if valid, and not processing the body portion of the first frame if invalid.

12. The method according to claim 11, wherein the method further comprises the following performed by the first entity:
if invalid, transmitting a second frame to a sender of the first frame to indicate a reception error.

13. The method according to claim 11, wherein the tail portion includes a second check field for checking the entire first frame, and determining whether the entire first frame is valid comprises:
determining whether the entire first frame is valid based on the second check field.

14. The method according to claim 11, wherein the body portion of the first frame comprises a frame number field, and processing the body portion of the first frame comprises:
determining whether the frame number field of the first frame is identical with a frame number field of one of a predefined number of frames received before the first frame from a sender of the first frame, and if so, not performing any subsequent operation on the first frame; and/or
determining, based on the frame number field, whether a frame number of the first frame and a frame number of a last frame are consecutive, and if not, determining a missing frame number, constructing a third frame based on the missing frame number, and transmitting the third frame to a sender of the first frame to indicate the sender of the first frame to transmit a frame corresponding to the missing frame number.

15. The method according to claim 11, wherein the body portion of the first frame comprises a command field and a frame number field, and processing the body portion of the first frame comprises:
parsing the command field to determine whether the first frame is a frame for a segment transmission, and if so, after receiving the first frame and one or more frames for the segment transmission associated with the first frame, determining whether frame numbers indicated by frame number fields in the first frame and the one or more frames are consecutive,
if consecutive, performing operations on the first frame and the one or more frames in a predefined order based on the frame number field; and
if not consecutive, determining a missing frame number, constructing a third frame based on the missing frame number, and transmitting the third frame to a sender of the first frame to indicate the sender of the first frame to transmit a frame corresponding to the missing frame number.

16. The method according to claim 11, wherein the method further comprises the following performed by the first entity:
receiving a fourth frame, the fourth frame includes a body portion; and
determining whether the fourth frame is valid, processing the body portion of the fourth frame if valid, and not processing the body portion of the fourth frame if not,
wherein the body portion of the fourth frame includes a command field, and processing the body portion of the fourth frame comprises:
parsing the command field to obtain a reception result of a fifth frame transmitted before receiving the fourth frame, and if the reception result indicates a reception error, retransmitting the fifth frame.

17. The method according to claim 16, wherein the body portion of the fourth frame further includes a frame number field, and processing the body portion of the fourth frame further comprises:
determining the fifth frame that the command field is for based on the frame number field.

18. The method according to claim 16, wherein processing the body portion of the fourth frame further comprises:
if the reception result indicates a reception error and the transmission number of the fifth frame reaches a predefined value, not retransmitting the fifth frame.

19. A self-service terminal comprising an application module configured to provide an application to a user, a printer, and a control module for a communication between the application module and the printer, wherein the control module is configured to:
receive a first frame from the application module; and
determine whether the first frame is valid, processing the first frame if valid, and not processing the first frame if not,
wherein the first frame includes a command field indicating one or more entities that the first frame is for and one or more operations associated with the one or more entities, and a data field associated with the one or more operations, and processing the first frame comprises:
parsing the command field to obtain the one or more entities and the one or more operations, and performing the following operations according to the one or more entities:
if the one or more entities include the printer, constructing a second frame for the printer based on the one or more operations, the data field, and a predefined rule between the control module and the printer, and transmitting the second frame to the printer; and
if the one or more entities include the control module, performing an operation based on the one or more operations and the data field.

20. The self-service terminal according to claim 19, further comprising a graphic code reader, the control module further for a communication between the application module and the graphic code reader, wherein the control module is further configured to:
receive a third frame from the graphic code reader; and
determine whether the third frame is valid, processing the third frame if valid, and not processing the third frame if not,
wherein the third frame includes a data field indicating data read by the graphic code reader, and processing the third frame comprises:
constructing a fourth frame for the application module based on a predefined rule between the control module and the application module, wherein the fourth frame includes a command field and a data field, the command field indicates an entity with which the fourth frame is associated is the graphic code reader and an operation with which the entity is associated is that data have been read, and the data field indicates data read by the graphic code reader; and
transmitting the fourth frame to the application module.
